(19) United States
(12) Patent Application Publication
(10) Pub. No.: US 2013/0290643 A1
(43) Pub. Date: Oct. 31, 2013

(54) USING A CACHE IN A DISAGGREGATED MEMORY ARCHITECTURE

(71) Applicants: Kevin T. Lim, La Honda, CA (US); Alvin Au Young, San Jose, CA (US)

(72) Inventors: Kevin T. Lim, La Honda, CA (US); Alvin Au Young, San Jose, CA (US)

(21) Appl. No.: 13/460,344

(22) Filed: Apr. 30, 2012

(51) Int. Cl. G06F 12/08

(52) U.S. Cl. 711/144; 711/E12.037

(57) ABSTRACT

Example caches in a disaggregated memory architecture are disclosed. An example apparatus includes a cache to store a first key in association with a first pointer to a location at a remote memory. The location stores a first value corresponding to the first key. The example apparatus includes a receiver to receive a plurality of key-value pairs from the remote memory based on the first key. The first value specifies the key-value pairs for retrieval from the remote memory.

### BACKGROUND

Memory blades may be used to provide remote memory capacity in disaggregated memory architectures. Memory blades may be implemented using remote dynamic random access memory (DRAM) connected to a local DRAM via a high-speed interconnect such as PCI Express (PCIe) or HyperTransport (HT). Disaggregated memory architectures often leverage either a hypervisor or glueless symmetric multiprocessing (SMP) support to enable access to the remote DRAM from the local DRAM.

### BRIEF DESCRIPTION OF THE DRAWINGS

FIG. 1 depicts an example disaggregated memory-based key-value caching system implemented in accordance with the teachings disclosed herein.

FIG. 2 depicts example apparatus that may be used in connection with the example system of FIG. 1 to offload a get-multi-get process to a remote memory blade.

FIG. 3 depicts example apparatus that may be used in connection with the example system of FIG. 1 to offload eviction candidate selection processes to a remote memory blade.

FIG. 4 depicts a flow diagram representative of example machine readable instructions that can be executed to implement the example apparatus of FIG. 2 to send a get-multi-get command to a remote memory blade.

FIG. 5 depicts a flow diagram representative of example machine readable instructions that can be executed to implement the example apparatus of FIG. 2 to execute a get-multi-get command on a remote memory blade.

FIG. 6 depicts a flow diagram representative of example machine readable instructions that can be executed to implement the example apparatus of FIG. 3 to offload eviction candidate selection processes to a remote memory blade.

FIG. 7 depicts a flow diagram representative of example machine readable instructions that can be executed to implement the example apparatus of FIG. 3 to perform eviction candidate selection on a remote memory blade.

FIG. 8 depicts a flow diagram representative of example machine readable instructions that can be executed to implement the example apparatus of FIG. 3 to perform a cache replacement process.

### DETAILED DESCRIPTION

Example apparatus, methods, and articles of manufacture disclosed herein may be used to perform cache operations using a disaggregated memory architecture. Examples disclosed herein enable offloading cache operations from a local compute node to a processor on a remote memory blade, for example. Offloading cache operations from the local compute node in examples disclosed herein reduces processing loads of a local central processing unit (CPU) without imposing additional substantial latency to local cache operations.

In-memory key-value caches allow data to be stored in memory using key-value pairs. In-memory key-value caches have become widely used to provide low-latency, high-throughput access to unstructured objects and other data. One such in-memory key-value cache is Memcached. Memcached is an open source distributed memory object caching system that provides an in-memory key-value store for small amounts of arbitrary data (e.g., strings, objects, etc.) that result from database calls, API calls, page renderings, etc. Memcached is widely used for Internet-tier workloads. In some examples, a separate Memcached server caches database objects as they are read from a database. By caching database objects in this manner, the Memcached server decreases loads on the database tier. To provide low-latency, high-speed access to data, key-value caches keep data in-memory and have large memory capacities to allow a significant amount of accessed data to be cached. However, upon failure, such key-value caches have difficulty providing a fast recovery. It is often time-consuming and requires significant resources to repopulate the cache after a restart to ensure continued low-latency operation as the cache may store significantly large quantities of objects (e.g., millions of objects).

In some examples, disaggregated memory architectures include a remote memory capacity through a memory blade, connected via a high-speed interconnect such as PCI Express (PCIe) or HyperTransport (HT), for example. In such examples, a remote dynamic random access memory (DRAM) in a memory blade is used in combination with a local DRAM, and the disaggregated memory system uses either a hypervisor or glueless symmetric multiprocessing (SMP) support to enable access to the remote DRAM. In some examples, the capacity of the remote DRAM is significantly larger than the local DRAM. Some known in-memory key-value cache implementations use disaggregated memory to provide required DRAM capacities. Some such known uses of disaggregated memory locate the remote DRAM in a failover domain separate from the local DRAM (e.g., a local DRAM at a local compute node) so that data stored at the remote DRAM survives local DRAM failures or local compute node failures (e.g., local failures that may result in loss of local data) requiring reboots of the compute node and its local DRAM. Example apparatus, methods, and articles of manufacture disclosed herein enable using disaggregated memory architectures to provide the capacity requirements of in-memory key-value caches while maintaining relatively low-latency and relatively high-throughput in such systems and enabling relatively fast recoveries from local compute node failures and/or local memory failures.

Some examples disclosed herein enable offloading multi-get processes from a compute node to a remote memory blade using a get-multi-get command. In such examples, the compute node submits an initial key (e.g., k₁) to the remote memory blade using a get-multi-get command. In such examples, the remote memory blade performs a get operation using the initial key (k₁) and performs a multi-get operation for a value (e.g., v₁) returned from the initial get operation. The remote memory blade returns to the compute node the value (e.g., v₁) associated with the initial key, as well as any other key-value pairs (e.g., <kₙ, vₙ>) indicated by the value (v₁) and retrieved using the multi-get operation. As such, examples disclosed herein enable multiple requests and values to be batched into a single response from a remote memory blade to a local compute node. In some disclosed examples, a significant amount of processing is offloaded from the compute node to the remote memory blade because the compute node can send a single get-multi-get command to the memory blade to cause the memory blade to return a plurality of values corresponding to a plurality of respective keys based on the single get-multi-get command. The amount of processing at the compute node is reduced by not needing the compute node to send multiple get commands to individually request the plurality of values for respective key-value pairs. In addition, network resources are conserved by not sending multiple, separate get commands. Further, latency and throughput between the compute node and memory blade is improved as round-trip time of sending and/or receiving additional commands is reduced and/or eliminated.

Some examples disclosed herein enable offloading an eviction candidate selection process from a compute node to a memory blade. In such examples, the compute node generates a least recently used (LRU) list of keys (corresponding to least recently used objects) and provides this LRU list to the memory blade. The memory blade steps through the LRU list of keys, selects objects that are candidates for potential eviction, and stores eviction candidate keys associated with the objects in an eviction candidate key queue. The memory blade transfers the eviction candidate keys queue to the compute node. In some examples, the memory blade sends updated eviction candidate key queues to the compute node periodically or aperiodically. When the compute node determines that it needs additional cache space to store a new object, it pops a key (associated with a potential eviction candidate object) from the eviction candidate queue as a potential eviction candidate. When the compute node confirms that the potential eviction candidate object may be evicted, it removes the object or marks the object as overwriteable or invalid to create space to store the new object. Using examples disclosed herein, a memory blade can perform the eviction candidate selection process to identify eviction candidate keys in advance (e.g., periodically or aperiodically as set by a user or program) rather than on an on-demand basis (e.g., when the compute node needs to perform an eviction). As such, examples disclosed herein enable the memory blade to provide a compute node with multiple eviction candidate keys at a time identified during a single eviction candidate selection process, rather than requiring the memory blade to identify a single eviction candidate on demand each time additional space is needed by the compute node and providing only one candidate at a time.

While examples are disclosed herein in connection with a disaggregated memory in which remote levels of DRAM are provided using memory blades, other suitable tiered memory systems having disjoint memory regions with different performance, cost, power and/or other characteristics may additionally or alternatively be used provided the tiers offer suitable performance for the in-memory key-value caches. Tiered memory solutions may include, for example, a hybrid DRAM/Memristor main memory or a hybrid embedded-DRAM/off-chip DRAM main memory. In some examples, control over the placement of data can be achieved either through non-uniform memory access (NUMA) aware operating systems or through an application programming interface (API) that allows read and write commands to be issued to remote memory. In the illustrated examples disclosed herein, an API is used.

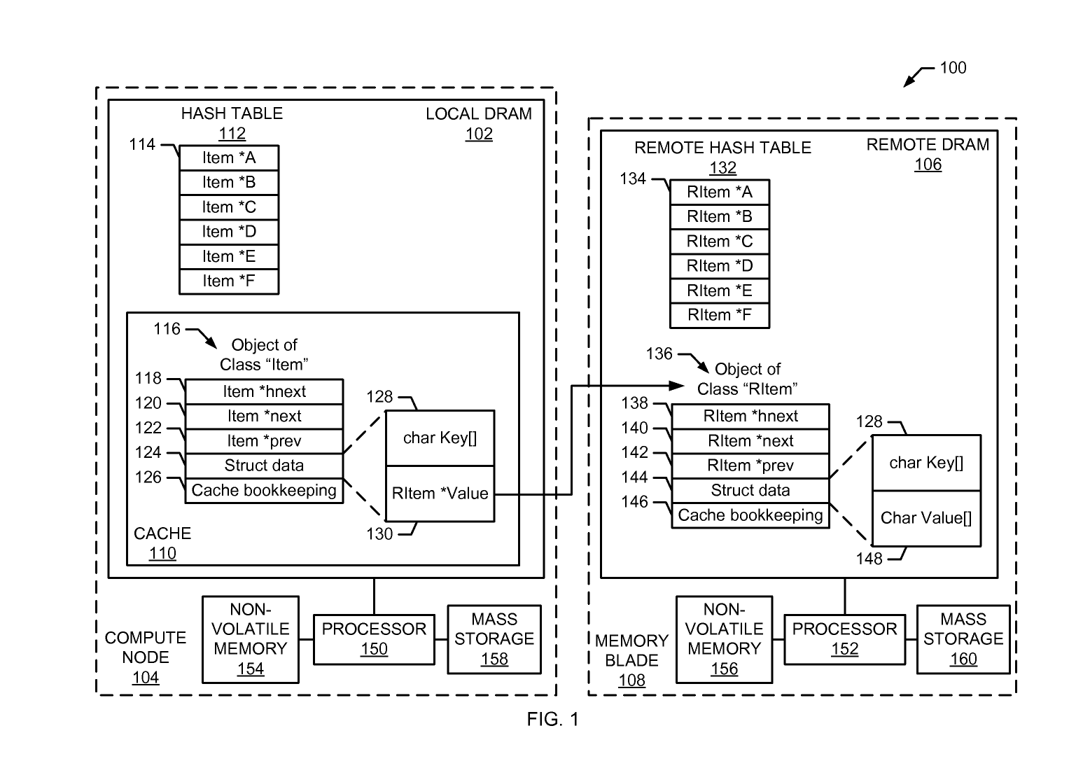

FIG. 1 illustrates an example disaggregated memory-based key-value caching system 100 that may be used to implement key-value caching systems. The system 100 of the illustrated example includes a compute node 104 (e.g., a local compute node) in communication with a memory blade 108 (e.g., a remote memory blade). The example compute node 104 includes a local DRAM 102 that is local relative to the compute node 104 to implement a key-value cache 110. In the illustrated example, the local level of DRAM 102 located at the compute node 104 is supplemented using a remote level of DRAM 106 located at the memory blade 108. The local DRAM 102 stores keys for the key-value cache 110 and the remote DRAM 106 stores values associated with the keys. The segregated data organization of the example system 100 of FIG. 1 enables performing key lookups in the local DRAM 102 for relatively fast access and enables storing values associated with the keys on the remote DRAM 106, which provides a relatively larger storage capacity for storing such values than the local DRAM 102. To enable storing keys in the local DRAM 102 and values in the remote DRAM 106, examples disclosed herein store key-pointer pairs (e.g., a key 128 and a corresponding RItem *Value pointer 130) in the local DRAM 102. As such, a unique key is stored in association with a pointer in the local DRAM 102, and the pointer points to a location in the remote DRAM 106 storing a value corresponding to the unique key. In this manner, a key-value pair is stored across the local DRAM 102 and the remote DRAM 106 by way of a key-pointer pair in the local DRAM 102 and a corresponding value in the remote DRAM 106. The example system 100 of FIG. 1 also enables the memory blade 108 to perform parallel (e.g., background) operations on key-value caches, thus, offloading a significant amount of processing from the local DRAM 102 and the compute node 104. In some examples, a portion of the local DRAM 102 may be used to store frequently written data (e.g., counter values) and/or for caching recently accessed objects.

Previous key-value caches, such as Memcached, have hash tables. In such previous key-value caches, keys are hashed at the hash table and used as indexes into the hash table. Such previous hash tables store pointers to objects of class “Item,” which store data corresponding to key-value pairs (e.g., a <key,value> pair). For example, an object of the class Item may store a pointer to a next hash table entry, pointers to next and previous objects of class Item (e.g., which may be used for choosing objects for eviction from the key-value cache), data associated with the object (e.g., a key and a value), and/or cache bookkeeping information (e.g., expiration times and reference counts). In such previous key-value caches, the hash table is used to perform a lookup of a client-specified key by scanning the hash table for a pointer to an object with the specified key. The hash lookup enables receiving a key from a client and returning the key and the corresponding value to the client. In previous systems (e.g., in a single-memory system), both the keys and values associated with keys in the hash table are stored in a local DRAM. Accessing and managing large hash tables places a significant load on local DRAMs of such previous systems. The example disaggregated memory-based key-value caching system 100 of FIG. 1 enables separately storing keys in the local DRAM 102 and corresponding values in the remote DRAM 106.

In the illustrated example, a hash table 112 is stored in the local DRAM 102 to store pointers 114 to objects (e.g., an Item object 116) associated with the key-pointer pairs stored in the key-value cache 110. Item objects (e.g., the Item object 116) store information corresponding to each key-pointer pair stored in the key-value cache 110. For example, the pointer “Item *A” in the hash table 112 points to the Item object 116 of FIG. 1. For ease of illustration, one Item object 116 is shown in the example of FIG. 1. However, the key-value cache 110 stores multiple Item objects. The Item object 116 of the illustrated example has a pointer 118 to a next hash table entry (not shown) that maps to the same hash table entry. The Item object 116 of the illustrated example has a pointer 120 to a next Item object (e.g., a next object of class Item similar to object 116) in the same hash table 112. In the illustrated example, the Item object 116 corresponds to the “Item *A” pointer in the hash table 112, and the next Item object relative to the Item object 116 is the Item object associated with an “Item *B” pointer in the hash table 112. The Item object 116 of the illustrated example stores a pointer 122 to a previous Item object (e.g., a previous object of class Item similar to object 116) in the same hash table 112. The pointers 120 and 122 may be used for choosing objects to be evicted from the key-value cache 110. The Item object 116 of the illustrated example also stores data 124 corresponding to the Item object 116 and cache bookkeeping information 126 (e.g., expiration times and reference counts). The data 124 of the illustrated example includes a key 128 of the Item object 116. The key 128 of the illustrated example is used as an index to uniquely reference, identify, and/or distinguish the Item object 116 relative to other Item objects in the key-value cache 110. Instead of storing a value corresponding to the key 128 as done in previous systems (e.g., single memory systems), the data 124 stores a pointer 130 (e.g., “RItem *Value”) to a memory location at the memory blade 108 that stores the value corresponding to the key 128 to form a key-value pair. Thus, although referred to herein as a key-value cache 110, the key-value cache 110 of the illustrated example does not store cached values of key-value pairs, but it does store keys (e.g., the key 128) and corresponding pointers (e.g., the pointer 130) as disclosed herein to access corresponding values stored in one or more separate memory stores (e.g., the memory blade 108).

In the segregated data organization disclosed herein, an independent copy of the hash table 112 is also stored in the remote DRAM 106 as hash table 132. The remote hash table 132 in the remote DRAM 106 operates in a similar manner to the hash table 112 in the local DRAM 102. The remote hash table 132 stores pointers 134 to class RItem objects (e.g., class RItem object 136). RItem objects (e.g., RItem object 136) are stored in the remote DRAM 106 and inherit from the Item objects (e.g., the Item object 116) stored in the local DRAM 102. Thus, when Item objects are accessed (e.g., allocated, deleted, updated, etc.) at the compute node 104, the associated RItem objects are accessed (e.g., allocated, deleted, updated, etc.) on the memory blade 108. For ease of illustration, one RItem object 136 is shown in FIG. 1. However, the remote DRAM 106 of the illustrated example stores multiple RItem objects. The RItem object 136 stores a pointer 138 to a next hash table entry (not shown) that maps to the same hash table entry. The RItem object 136 stores a pointer 140 to a next RItem object (e.g., a next object of class RItem similar to object 136) in the hash table 134 and a pointer 142 to a previous RItem object (e.g., a previous object of class RItem similar to object 136) in the hash table 134. The pointers 140 and 142 may be used for choosing objects to be evicted from the key-value cache 110 at the compute node 104. The RItem object 136 stores data 144 corresponding to the RItem object 136 and cache bookkeeping information 146 (e.g., expiration times and reference counts). The data 144 of the RItem object 136 includes the key 128 and a corresponding value 148. Thus, the RItem object 136 at the remote DRAM 106 contains the value 148 (e.g., data associated with the key 128), and the Item object 116 at the local DRAM 102 contains the pointer 130 to the RItem object 136. In the illustrated example, the compute node 104 receives a key 128 from a client and performs a hash lookup. A hash lookup requires the compute node 104 to scan the hash table 112 for a pointer 114 to an Item object with the key 128 (Item object 116 in the illustrated example). If the key 128 is found, the memory blade 108 is directly accessed based on the pointer 130 to return the value 148 associated with the key 128.

In the illustrated example, the remote hash table 132 of the remote DRAM 106 provides a backup for the local hash table 112 at the compute node 104. The remote hash table 132 enables fast recovery of cache contents in the event of a failure at the local DRAM 102 or the compute node 104. If the compute node 104 crashes and contents of the local DRAM 102 are lost, corrupted, and/or unreliable, upon reboot, the key-value cache 110 at the compute node 104 can enter a special recovery mode. This recovery mode enables the compute node 104 to coordinate with the memory blade 108 to copy the remote hash table 132 and the RItem objects of the remote blade 108 to the local hash table 112 and the Item objects of the compute node 104. In some examples, recovery mode copies RItem objects by converting the RItem objects (e.g., the RItem object 136) to Item objects (e.g., the Item object 116).

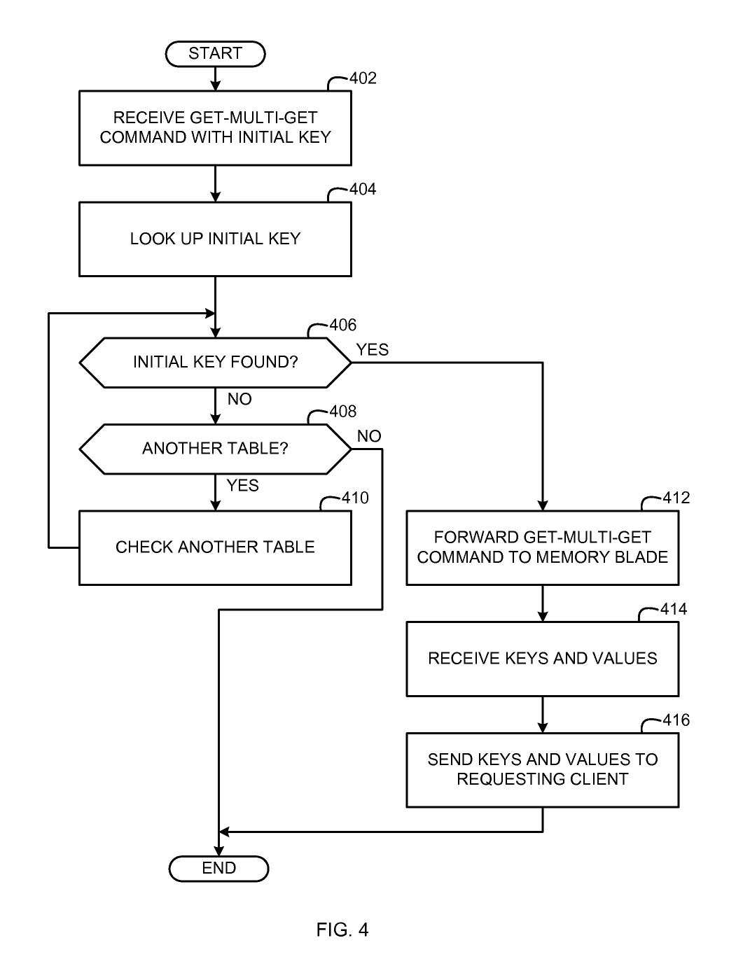

In the illustrated example, the compute node 104 includes a processor 150, and the memory blade 108 includes a processor 152. Each of the processors 150 and 152 can be implemented by one or more microprocessors or controllers from any desired family or manufacturer. Also in the illustrated example, the compute node 104 and the memory blade 108 include respective non-volatile memories 154 and 156. The processor 150 of the illustrated example is in communication with the local DRAM 102 and the non-volatile memory 154. The processor 152 of the illustrated example is in communication with the remote DRAM 106 and the non-volatile memory 156. In some examples, the non-volatile memories 154 and 156 store machine readable instructions that, when executed by the processors 150 and 152, cause the processors 150 and 152 to perform examples disclosed herein. In the illustrated example, the non-volatile memories 154 and 156 may be implemented using flash memory and/or any other type of memory device. The compute node 104 and the memory blade 108 of the illustrated example may also include one or more mass storage devices 158 and 160 to store software and/or data. Examples of such mass storage devices 158 and 160 include floppy disk drives, hard drive disks, compact disk drives and digital versatile disk (DVD) drives. The mass storage devices 158 and 160 implement a local storage device. In some examples, coded instructions of FIGS. 4, 5, 6, 7, and/or 8 may be stored in the mass storage devices 158 and 160, in the DRAM 102 and 106, in the non-volatile memories 154 and 156, and/or on a removable storage medium such as a CD or DVD. The compute node 104 and the memory blade 108 of the illustrated example may be connected via the Internet, an intranet, a local area network (LAN), or any other public or private network, or an on-board bus or intra-stack bus (e.g., for three-dimensional (3D) stack chips having one or more processor die and/or one or more stacked DRAM die).

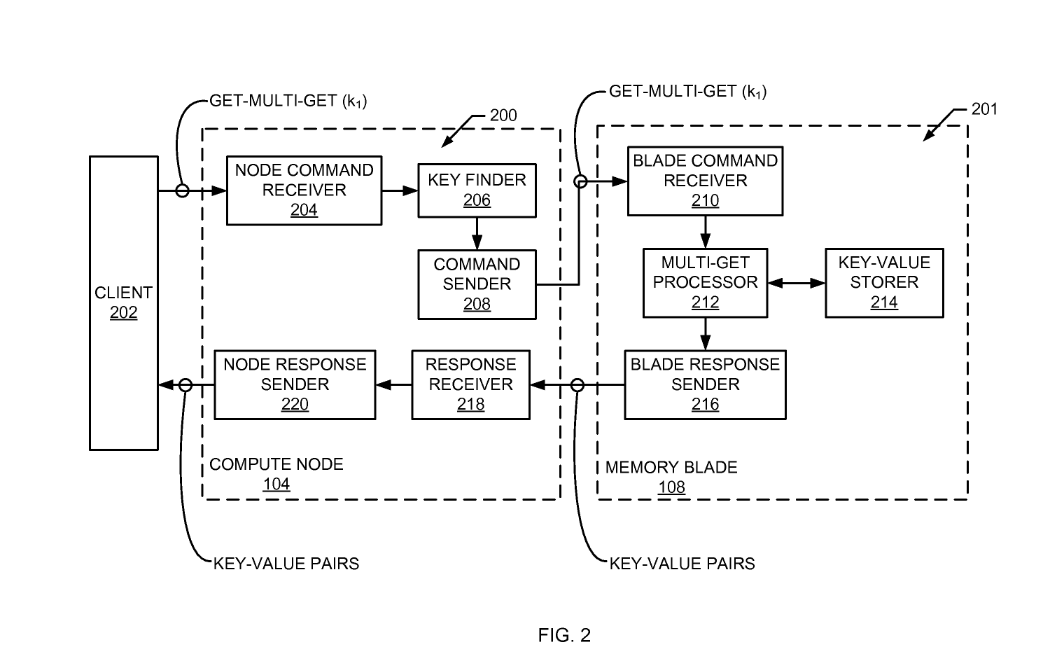

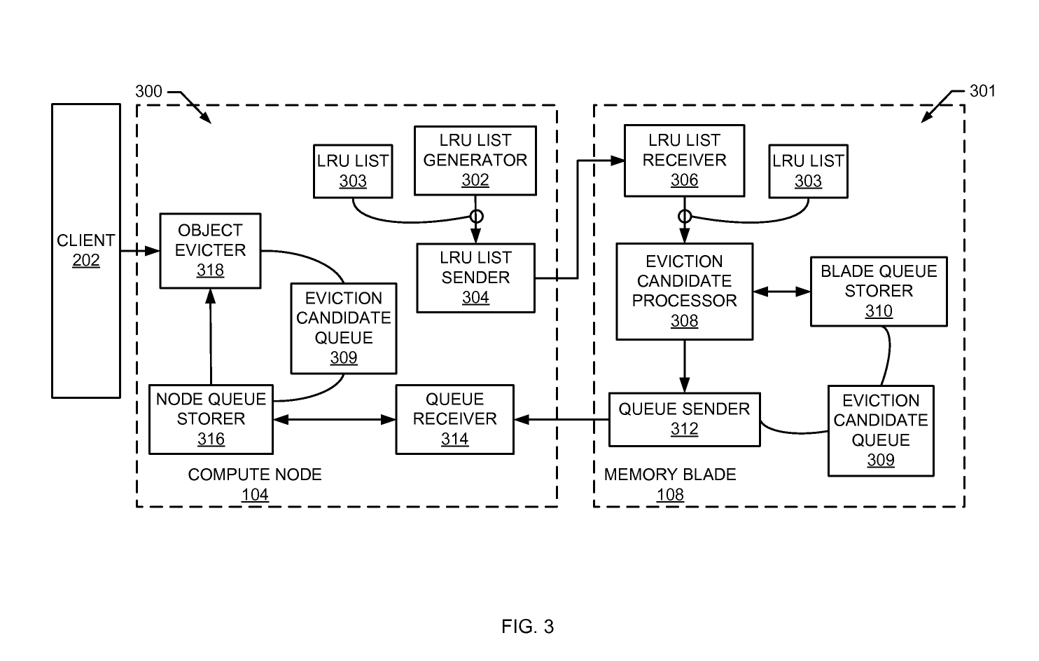

The disaggregated memory system 100 and the remote hash table 132 of the illustrated example enable the memory blade 108 to execute get-multi-get commands and/or to select candidates for eviction from the key-value cache 110 to reduce processing and memory resources required from the compute node 104. FIG. 2 depicts example apparatus 200 and 201 that can be used to offload a get-multi-get process to the remote memory blade 108, and FIG. 3 depicts example apparatus 300 and 301 that can be used to offload cache replacement selection operations to the remote memory blade 108. In the illustrated example, the apparatus 200 and 201 are separate from the apparatus 300 and 301. However, in some examples, the apparatus 200 and 300 may be implemented together in the compute node 104 and the apparatus 201 and 301 may be implemented together in the remote memory blade 108.

Get-multi-get processes enable batching values for multiple keys into a single response. In known key-value cache accesses (e.g., executed on a single memory), a compute node receives a get command with an initial key (e.g., k₁) and returns a value (e.g., v₁), which is a list of keys (e.g., k₂, k₃ . . . kₙ) to be looked up. The compute node then receives a multi-get command from the client with the list of keys and performs individual lookups for each key in the list. The compute node returns the values associated with the list of keys to the client. Using the example apparatus 200 and 201 disclosed herein, a get-multi-get command is sent to the compute node 104 from a client 202 with an initial key (e.g., GET-MULTI-GET (k₁)). The compute node 104 sends the get-multi-get command to the memory blade 108, and the memory blade 108 returns the keys and values associated with the initial key to the compute node 104. The compute node 104 then returns the keys and values associated with the initial key to the client 202.

In the illustrated example of FIG. 2, the apparatus 200 at the compute node 104 includes an example node command receiver 204, an example key finder 206, an example command sender 208, an example response receiver 218, and an example node response sender 220. The node command receiver 204 of the illustrated example receives a get-multi-get command with an initial key (e.g., GET-MULTI-GET (k₁)) from the client 202. The node command receiver 204 sends the command with the initial key to the key finder 206. The key finder 206 searches one or more hash tables (e.g., the hash table 112 of FIG. 1) stored at the compute node 104 for the initial key. For example, the key finder 206 searches one or more hash tables for a pointer (e.g., one of the pointers 114 of FIG. 1) to an object (e.g., the Item object 116 of FIG. 1) with the initial key. If the initial key is found (e.g., if the initial key has been hashed in a hash table of the compute node 104), the key finder 206 sends the get-multi-get command and the initial key to the command sender 208 that passes the get-multi-get command with the initial key (e.g., GET-MULTI-GET (k₁)) to the memory blade 108. The initial key being found at the compute node 104 by the key finder 206 indicates that the memory blade 108 stores corresponding keys and values (e.g., key-value pairs) retrievable by the memory blade 108 using the get-multi-get command. In the illustrated example, if the key finder 206 does not find the initial key at the compute node 104, the compute node 104 returns a message informative of the absent key (e.g., an error message) to the client 202.

In the illustrated example, the apparatus 201 at the memory blade 108 includes an example blade command receiver 210, an example multi-get processor 212, an example key-value storer 214, and an example blade response sender 216. The blade command receiver 210 of the illustrated example receives the get-multi-get command with the initial key from the compute node 104 and sends the command and the initial key to the multi-get processor 212. The multi-get processor 212 performs a lookup for the initial key using one or more remote hash tables (e.g., the remote hash table 132 of FIG. 1) of the memory blade 108. A value associated with the initial key is returned to the multi-get processor 212 that is a list of other keys. The multi-get processor 212 then performs key lookups for each key contained in the list of keys. When the multi-get processor 212 performs the key lookups and retrieves one or more values associated with each key, the multi-get processor 212 sends the keys and values (e.g., key-value pairs) to the key-value storer 214, and the key-value storer 214 stores the key-value pairs. If there is no value associated with a key, the multi-get processor 212 sends a null value for that key to the key-value storer 214 for storage. Once the multi-get processor 212 has performed a key lookup for each key contained in the list of keys, the multi-get processor 212 retrieves the key-value pairs from the key-value storer 214 and sends them to a blade response sender 216. In the illustrated example, the blade response sender 216 sends the key-value pairs to the compute node 104. The response receiver 218 at the compute node 104 receives the key-value pairs and sends them to the node response sender 220. In the illustrated example, the node response sender 220 sends the key-value pairs to the client 202 as a response to the get-multi-get command (e.g., GET-MULTI-GET (k₁)) received from the client 202 at the node command receiver 204.

The example apparatus 200 and 201 of FIG. 2 enable multiple values corresponding to an initial key to be batched into a single response to a requesting client (e.g., the client 202). In the examples disclosed herein, a significant amount of processing is offloaded from the compute node 104 to the remote memory blade 108 as the compute node 104 sends a single get-multi-get command to the memory blade 108, rather than multiple get commands, and the compute node 104 does not perform the multiple get operations itself.

Turning in detail to FIG. 3, the example apparatus 300 and 301 may be used to offload eviction candidate selection processes to a remote memory blade (e.g., the memory blade 108). When a key-value cache (e.g., Memcached) runs out of free memory, it evicts current objects (e.g., the Item object 116 of FIG. 1) when it receives requests to create or add new objects. Often times, to select eviction candidates (e.g., eviction candidate objects), a list is created of least-recently used (LRU) objects within the cache (e.g., oldest used objects to newest used objects) with the expectation that objects that have not been used recently are less likely to be used in the near future. The LRU list is a list of keys associated with the least-recently used objects. In some examples, cache replacement policies may affect whether an eviction candidate may actually be evicted. For example, some objects may be stored with an expiry time such that the object may be evicted if the current time exceeds the expiry time. In another example, objects may be stored with a reference count such that that object may not be evicted if the reference count is greater than zero. The reference count may indicate that the object is being accessed. In traditional Memcached systems, LRU-based eviction occurs on an on-demand basis (e.g., only when there is insufficient memory space to create or store a new object will the system check for an LRU item to evict). Additionally, in traditional Memcached systems, only one eviction candidate is selected from the LRU list at a time for eviction from the key-value cache.

A remote hash table (e.g., the remote hash table 132 of FIG. 1) and data (e.g., cache bookkeeping information 146) related to the objects (e.g., the RItem object 136) stored at the memory blade 108 enable offloading the eviction candidate selection process to the memory blade 108. In the illustrated example, the memory blade 108 generates an eviction candidate queue that contains keys of potential eviction candidates based on the LRU list created by the compute node 104. The memory blade 108 sends the eviction candidate queue to the compute node 104 and the compute node 104 uses the eviction candidate queue to select objects for eviction.

In the illustrated example, the apparatus 300 at the compute node 104 includes an example LRU list generator 302, an example LRU list sender 304, an example queue receiver 314, an example node queue storer 316, and an example object evictor 318. In the illustrated example, the LRU list generator 302 at the compute node 104 generates an LRU list 303 and sends the LRU list 303 to an LRU list sender 304. In the illustrated example, the LRU list generator 302 generates the LRU list 303 based on the least recently used objects (e.g., the Item object 116 of FIG. 1). The LRU list sender 304 of the illustrated example sends the LRU list 303 to the memory blade 108.

In the illustrated example, the apparatus 301 at the memory blade 108 includes an example LRU list receiver 306, an example eviction candidate processor 308, an example blade queue storer 310, and an example queue sender 312. In the illustrated example, the LRU list receiver 306 at the memory blade 108 receives the LRU list 303 and sends the LRU list 303 to the eviction candidate processor 308. The eviction candidate processor 308 of the illustrated example steps through the LRU list 303 (e.g., using the next and previous pointers 140 and 142 within the RItem object 136 of FIG. 1), selects candidates for potential eviction, and saves their associated keys onto an eviction candidate queue 309 at a blade queue storer 310. The eviction candidate processor 308 may select candidates for potential eviction based on a variety of cache replacement policies (e.g., expiration times, reference counts, etc.) and/or in a variety of ways. In the illustrated example, the eviction candidate processor 308 selects an object as a candidate for potential eviction if the object is expired and has no reference count. In some examples, the eviction candidate processor 308 selects an object as a candidate for potential eviction if the object has a low reference count (e.g., if no expiration data is available). In some examples, the eviction candidate processor 308 selects an object as a candidate for potential eviction if the object is a least recently used object. Once the eviction candidate processor 308 has created the eviction candidate queue 309, the queue sender 312 of the illustrated example transfers the eviction candidate queue 309 to the compute node 104. The queue sender 312 of the illustrated example may transfer the eviction candidate queue 309 periodically or aperiodically.

In the illustrated example, the queue receiver 314 at the compute node 104 receives the eviction candidate queue 309 from the memory blade 108 and sends the eviction candidate queue 309 to the node queue storer 316 for storage. The object evictor 318 of the illustrated example determines when the compute node 104 needs to evict an object to make room for an incoming object. When the object evictor 318 determines that the compute node 104 must evict an object, it pops (or selects) a key from the eviction candidate queue 309 stored at the compute node 104 as a potential eviction candidate. In the illustrated example, the object evictor 318 confirms whether the potential eviction candidate selected from the eviction candidate queue 309 (e.g., the object associated with the eviction candidate key) may be evicted. If so, the object evictor 318 removes the object using any suitable eviction process. If the candidate may not be evicted, the object evictor 318 may pop (or select) another key from the eviction candidate queue 309 and repeat the process. If no objects associated with the keys in the eviction candidate queue 309 are available for eviction, the object evictor 318 may resort to traditional methods of selecting objects for eviction.

The example apparatus 300 and 301 of FIG. 3 enables the eviction candidate selection process to occur periodically or aperiodically (e.g., as set by a user) rather than on-demand. Additionally, in the illustrated example of FIG. 3, the memory blade 108 provides the compute node 104 with multiple potential eviction candidates at a time, rather than only one candidate at a time. The apparatus 301 enables the memory blade 108 to compile the eviction candidate queue 309 without modifying the LRU list 303 provided by the apparatus 300 or the objects at the compute node 104. Accordingly, the memory blade 108 does not interrupt the compute node 104 while compiling the eviction candidate queue. Periods of frequent swapping of objects in the key-value cache often correspond to high processing activity at the compute node 104. Alleviating the compute node 104 of the eviction candidate selection improves performance at the compute node 104 during these periods.

While example implementations of the example apparatus 200, 201, 300, and 301 have been illustrated in FIGS. 2 and 3, one or more of the elements, processes and/or devices illustrated in FIGS. 2 and/or 3 may be combined, divided, re-arranged, omitted, eliminated and/or implemented in any other way. Further, the node command receiver 204, the key finder 206, the command sender 208, the blade command receiver 210, the multi-get processor 212, the key-value storer 214, the blade response sender 216, the response receiver 218, the node response sender 220, the LRU list generator 302, the LRU list sender 304, the LRU list receiver 306, the eviction candidate processor 308, the blade queue storer 310, the queue sender 312, the queue receiver 314, the node queue storer 316, the object evictor 318, and/or, more generally, the example apparatus 200, 201, 300, and/or 301 of FIGS. 2 and/or 3 may be implemented by hardware, software, firmware and/or any combination of hardware, software and/or firmware. Thus, for example, any of the node command receiver 204, the key finder 206, the command sender 208, the blade command receiver 210, the multi-get processor 212, the key-value storer 214, the blade response sender 216, the response receiver 218, the node response sender 220, the LRU list generator 302, the LRU list sender 304, the LRU list receiver 306, the eviction candidate processor 308, the blade queue storer 310, the queue sender 312, the queue receiver 314, the node queue storer 316, the object evictor 318, and/or, more generally, the example apparatus 200, 201, 300, and/or 301 of FIGS. 2 and/or 3 could be implemented by one or more circuit(s), programmable processor(s), application specific integrated circuit(s) (“ASIC(s)”), programmable logic device(s) (“PLD(s)”) and/or field programmable logic device(s) (“FPLD(s)”), etc. When any of the apparatus or system claims of this patent are read to cover a purely software and/or firmware implementation, at least one of the node command receiver 204, the key finder 206, the command sender 208, the blade command receiver 210, the multi-get processor 212, the key-value storer 214, the blade response sender 216, the response receiver 218, the node response sender 220, the LRU list generator 302, the LRU list sender 304, the LRU list receiver 306, the eviction candidate processor 308, the blade queue storer 310, the queue sender 312, the queue receiver 314, the node queue storer 316, and/or the object evictor 318 are hereby expressly defined to include a tangible computer readable medium such as a memory, DVD, compact disc (“CD”), etc. storing the software and/or firmware. Further still, the example apparatus 200, 201, 300, and/or 301 of FIGS. 2 and/or 3 may include one or more elements, processes and/or devices in addition to, or instead of, those illustrated in FIGS. 2 and/or 3, and/or may include more than one of any or all of the illustrated elements, processes and devices.

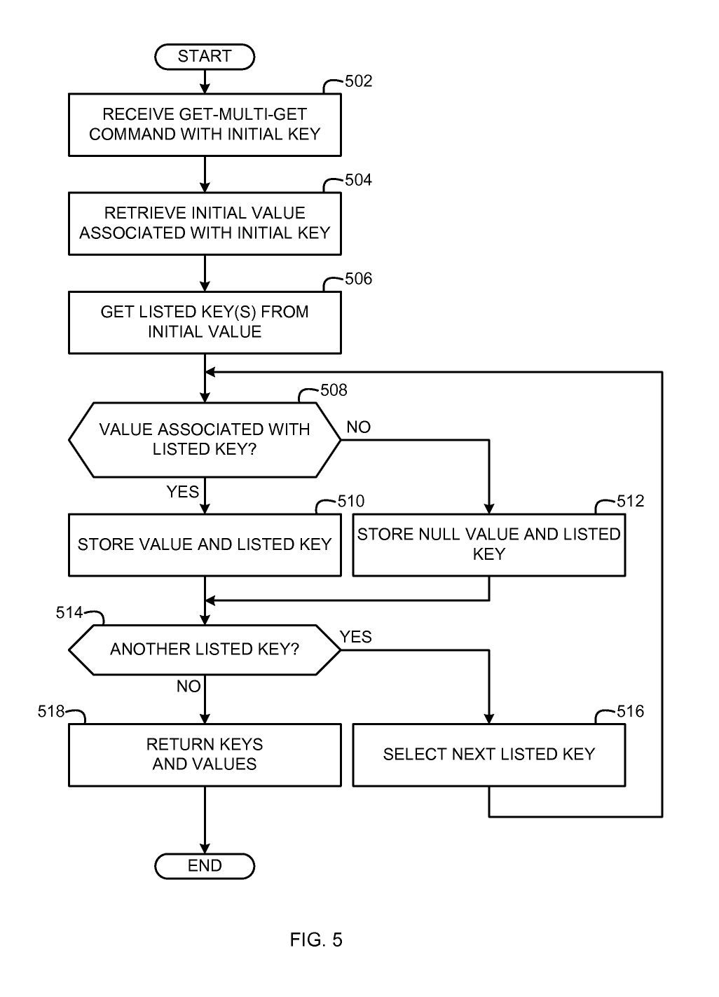

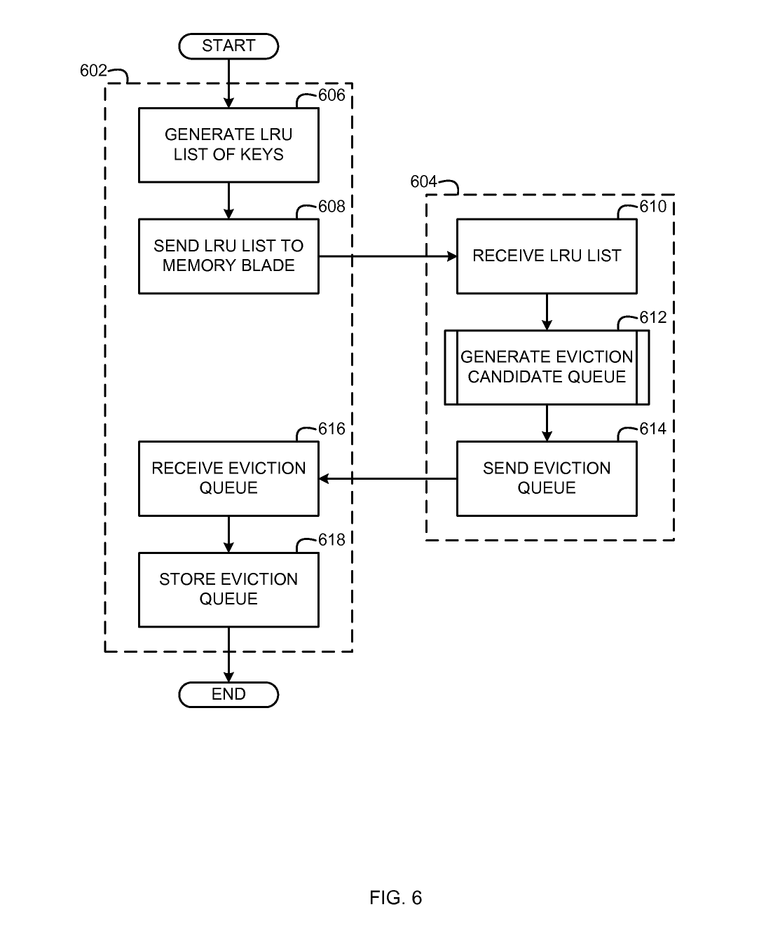

Flowcharts representative of example machine readable instructions for implementing the example apparatus 200 and 201 of FIG. 2 are shown in FIGS. 4 and 5 and flowcharts representative of example machine readable instructions for implementing the example apparatus 300 and 301 of FIG. 3 are shown in FIGS. 6, 7, and 8. In these examples, the machine readable instructions comprise one or more programs for execution by one or more processors similar or identical to the processor(s) 150 and/or 152 of FIG. 1. The program(s) may be embodied in software stored on a tangible computer readable medium such as a compact disc read-only memory (“CD-ROM”), a floppy disk, a hard drive, a DVD, Blu-ray disk, or a memory associated with the processor(s) 150 and/or 152, but the entire program(s) and/or parts thereof could alternatively be executed by one or more devices other than the processor(s) 150 and/or 152 and/or embodied in firmware or dedicated hardware. Further, although the example program(s) is/are described with reference to the flowcharts illustrated in FIGS. 4, 5, 6, 7, and 8, many other methods of implementing the example system 100, the example apparatus 200 and 201, and/or the example apparatus 300 and 301 may alternatively be used. For example, the order of execution of the blocks may be changed, and/or some of the blocks described may be changed, eliminated, or combined.

As mentioned above, the example processes of FIGS. 4, 5, 6, 7, and/or 8 may be implemented using coded instructions (e.g., computer readable instructions) stored on a tangible computer readable medium such as a computer readable storage medium (e.g., a hard disk drive, a flash memory, a read-only memory (“ROM”), a CD, a DVD, a Blu-ray disk, a cache, a random-access memory (“RAM”) and/or any other storage media in which information is stored for any duration (e.g., for extended time periods, permanently, brief instances, for temporarily buffering, and/or for caching of the information)). As used herein, the term tangible computer readable medium is expressly defined to include any type of computer readable storage medium and to exclude propagating signals. Additionally or alternatively, the example processes of FIGS. 4, 5, 6, 7, and/or 8 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

A flow diagram of an example process that can be used to offload a multi-get process to a remote memory blade (e.g., the memory blade 108 of FIGS. 1-3) using a get-multi-get command is illustrated in FIG. 4. To initiate the get-multi-get command process, the node command receiver 204 (FIG. 2) at the compute node 104 receives a get-multi-get command with an initial key (e.g., k₁) from a client (e.g., the client 202 of FIG. 2) (block 402). The key finder 206 (FIG. 2) performs a look up for the initial key (block 404) to determine if the initial key is located in a local key-value cache (e.g., the key-value cache 110) (block 406). For example, the key finder 206 determines if the initial key has been hashed in a local hash table (e.g., the hash table 112) so that the local hash table stores a pointer to an Item object corresponding to the initial key. If the initial key is not found (block 406), the key finder 206 determines if there is another local hash table in which the initial key may have been hashed (block 408). If there is another hash table that may store a pointer to an object having the initial key (block 408), the key finder 206 performs a hash look up for the initial key using the other hash table (block 410) and control returns to block 406. If there are no more local hash tables in which the initial key may have been hashed (block 408) and the initial key has not been found, the process of FIG. 4 ends. When the initial key is found (block 406), the command sender 208 (FIG. 2) forwards the get-multi-get command including the initial key to the remote memory blade 108 (block 412). After the memory blade 108 executes the get-multi-get command to retrieve and return one or more key-value pairs as described below in connection with FIG. 5, the response receiver 218 (FIG. 2) at the compute node 104 receives the keys and values from the memory blade 108 (block 414). The node response sender 220 (FIG. 2) sends the keys and values to a requesting client (e.g., the client 202 that sent the get-multi-get command) (block 416). The example process of FIG. 4 then ends.

A flow diagram of an example process that can be used to execute a get-multi-get command on a remote memory blade (e.g., the memory blade 108) is illustrated in FIG. 5. Initially, the blade command receiver 210 (FIG. 2) at the memory blade 108 receives the get-multi-get command with an initial key from the compute node 104 (block 502). The multi-get processor 212 (FIG. 2) performs a hash look up of the initial key (e.g., using the remote hash table 132) and retrieves a first value (e.g., v₁) associated with the initial key (block 504). The multi-get processor 212 gets listed key(s) (e.g., k₂, k₃ . . . kₙ) from the first value (e.g., the first value is a list of keys) (block 506). The multi-get processor 212 performs a lookup of a listed key and determines if there is a value corresponding to the listed key (block 508). If there is a value associated with the listed key (block 508), the key-value storer 214 (FIG. 2) stores the value with the listed key (block 510), and control advances to block 514 to determine if there is another listed key to lookup. If there is not a value associated with the listed key (block 508), the key-value storer 214 stores a null value with the listed key (block 512), and control advances to block 514. If there is another listed key to lookup (block 514), multi-get processor 212 selects a next listed key (block 516), and control returns to block 508. If there is not another listed key to lookup (e.g., when the multi-get processor 212 has performed a lookup for each of the listed keys defined by the first value) (block 514), the blade response sender 216 (FIG. 2) returns the keys and values (e.g., key-value pairs) to the compute node 104 (block 518), and the example process of FIG. 5 ends.

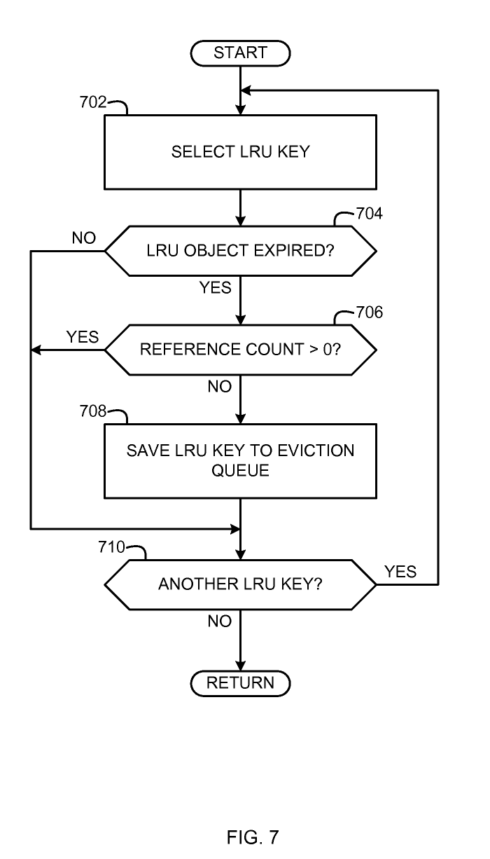

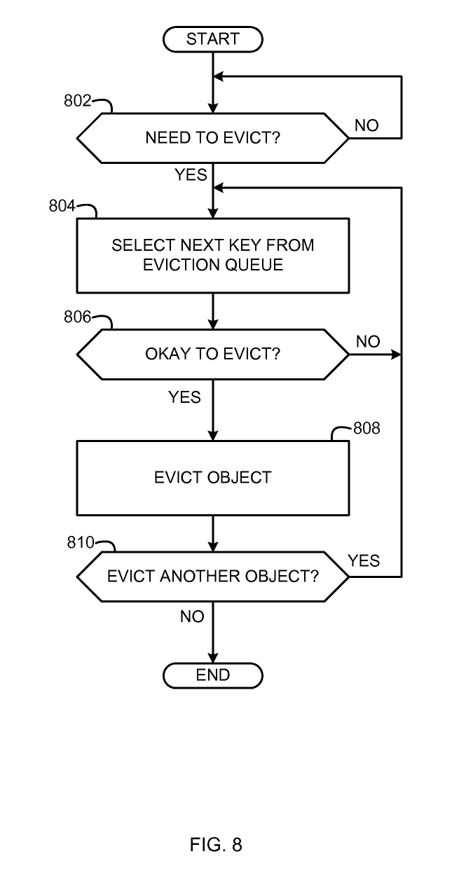

The flow diagram of FIG. 6 depicts an example compute node process 602 performed by the apparatus 300 of FIG. 3 and an example memory blade process 604 performed by the apparatus 301 of FIG. 3 that can be used to offload cache replacement selection operations to a remote memory blade (e.g., the memory blade 108). Initially, in the compute node process 602, the LRU list generator 302 (FIG. 3) at the compute node 104 generates an LRU list of keys (e.g., the LRU list 303 of FIG. 3) (block 606). The LRU list sender 304 (FIG. 3) sends the LRU list 303 to the memory blade 108 (block 608). The LRU list 303 may be provided to the memory blade 108 periodically or aperiodically (e.g., as it is updated, or after a certain number of updates have been made). In the example memory blade process 604, the LRU list receiver 306 (FIG. 3) at the memory blade 108 receives the LRU list 303 (block 610). The eviction candidate processor 308 (FIG. 3) generates an eviction candidate queue (e.g., the eviction candidate queue 309 of FIG. 3) (block 612). In the illustrated example, the eviction candidate processor 308 generates the queue 309 using the example process of FIG. 7. The queue sender 312 (FIG. 3) sends the eviction candidate queue 309 to the compute node 104 (block 614). Returning to the compute node process 602, the queue receiver 314 (FIG. 3) at the compute node 104 receives the eviction candidate queue 309 (block 616). The node queue storer 316 (FIG. 3) stores the eviction candidate queue 309 (block 618). The example process of FIG. 6 then ends. A process of evicting objects at the compute node 104 based on the eviction candidate queue is described below in connection with FIG. 8.

A flow diagram of an example process than can be used to generate the eviction candidate queue 309 at the remote memory blade 108 is illustrated in FIG. 7. In the illustrated example, the example process of FIG. 7 may be used to implement block 612 of FIG. 6. Initially, the eviction candidate processor 308 (FIG. 3) selects an LRU key from the LRU list 303 (block 702). The eviction candidate processor 308 determines if the object (e.g., the RItem object 136 of FIG. 1) associated with the selected LRU key is expired (block 704). In the illustrated example, to determine if the object is expired, the eviction candidate processor 308 accesses bookkeeping information (e.g., the bookkeeping information 146 of FIG. 1) stored in the object and checks the expiry information of the object. For example, if the expiry information indicates that an expiration date/time of the object has lapsed, the eviction candidate processor 308 determines that the object is expired after that time. The expiry time may be set by a user or a program, for example. If the object is expired (block 704), the eviction candidate processor 308 determines if the reference count of the object is greater than zero (block 706). In the illustrated example, the reference count of the object is stored in the cache bookkeeping information (e.g., the cache bookkeeping information 146 of FIG. 1). In the illustrated example, a reference count greater than zero indicates that the object is being accessed (e.g., data is currently being read) and should not be evicted. If the reference count of the object is not greater than zero, the blade queue storer 310 (FIG. 3) stores the key associated with the object in the eviction candidate queue 309 (block 708). If the object is not expired (block 704), if the reference count is greater than zero (block 706), or if the eviction candidate processor 308 has saved the key to the eviction candidate queue 309 (block 708), the eviction candidate processor 308 determines if there is another LRU key in the LRU list 303 (block 710). If there is another LRU key in the LRU list 303 (block 710), control returns to block 702. If there are no more LRU keys in the LRU list 303 (block 710), the example process of FIG. 7 ends, and control returns to a calling function or process such as the process of FIG. 6. In some examples, objects that do not have associated expiry information may have only their reference counts checked to determine if the objects are eviction candidates. In other examples, other information stored in the objects may be used to determine if the objects are eviction candidates.

A flow diagram of an example process than can be used to execute a cache replacement at the compute node 104 based on the stored eviction candidate queue 309 is illustrated in FIG. 8. Initially, the object evictor 318 (FIG. 3) at the compute node 104 determines if it needs to evict an object (e.g., the Item object 116 of FIG. 1) from the key-value cache (e.g., the key-value cache 110 of FIG. 1) (block 802). The compute node 104 may need to evict an object when the key-value cache 110 is full and a request to create or add a new object is received (e.g., from the client 202 of FIGS. 2 and 3). Control remains at block 802 until the compute node 104 needs to evict an object. Once the compute node 104 needs to evict an object (block 802), the object evictor 318 pops (or selects) a next key from the eviction candidate queue 309 stored by the node queue storer 316 (FIG. 3) (block 804). The object evictor 318 then determines if it may actually evict the object corresponding to the selected key (block 806). For example, the object evictor 318 may check the reference count of the object corresponding to the selected key to ensure that the object is not currently being accessed. Other additional or alternative checks may be performed to determine whether the object may be evicted. If the compute node 104 may evict the object (block 806), the object evictor 318 evicts the object (block 808). The object evictor 318 then determines if the compute node 104 needs to evict another object (block 810). If the compute node 104 does need to evict another object due to a request to enter a new object (block 810), control returns to block 804. If the compute node 104 does not need to evict another object (block 810), the example process of FIG. 8 ends. Offloading the eviction candidate selection process to the memory blade 108 as disclosed herein frees up the processing capabilities of the local compute node 104. Additionally, the examples disclosed herein allow the eviction candidate selection process to occur periodically or aperiodically (e.g., as set by a user) rather than on-demand. Also, in the examples disclosed herein, the memory blade 108 provides the compute node 104 with multiple potential eviction candidates at a time, rather than only one candidate at a time.

Although the above discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the above describes example methods, apparatus, and articles of manufacture, the examples provided are not the only way to implement such methods, apparatus, and articles of manufacture.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. An apparatus to use a cache in a disaggregated memory architecture, comprising:
a cache to store a first key in association with a first pointer to a location at a remote memory, the location to store a first value corresponding to the first key; and
a receiver to receive a plurality of key-value pairs from the remote memory based on the first key, the first value to specify the key-value pairs for retrieval from the remote memory.

2. The apparatus of claim 1, wherein the cache is located at a compute node separate from a memory blade comprising the remote memory.

3. The apparatus of claim 1, further comprising a command receiver to receive a command from a client, the command including the first key.

4. The apparatus of claim 3, further comprising a command sender to send the command with the first key to a memory blade comprising the remote memory.

5. The apparatus of claim 1, further comprising a key finder to determine if the first key is stored in the cache.

6. The apparatus of claim 5, wherein the key finder uses a hash table to determine if the first key is stored in the cache, the key finder to determine that the first key is stored in the cache when the hash table stores a second pointer to a cache object corresponding to the first key.

7. The apparatus of claim 1, further comprising a response sender to send the plurality of key-value pairs to a client.

8. A processor to use a cache in a disaggregated memory architecture, comprising:
a sender to send to a remote memory a list of least recently used keys stored in the cache; and
a receiver to receive an eviction candidate queue from the remote memory, the eviction candidate queue comprising at least some of the keys corresponding to cache objects indicated as candidates for removal from the cache.

9. The processor of claim 8, wherein the cache is located at a compute node separate from a memory blade comprising the remote memory.

10. The processor of claim 8, further comprising a list generator to generate the list of least recently used keys based on keys corresponding to cache objects having been least recently accessed at the cache.

11. The processor of claim 8, further comprising a queue storer to store the eviction candidate queue.

12. The processor of claim 8, further comprising an object evictor to remove at least one of the cache objects from the cache based on the eviction candidate queue.

13. The processor of claim 12, wherein the object evictor is to remove the at least one of the cache objects from the cache when a client requests to add a new cache object to the cache and the cache is full.

14. The processor of claim 12, wherein the object evictor is to remove the at least one of the cache objects from the cache if the one of the cache objects is at least one of not being accessed or expired.

15. A method to use a cache in a disaggregated memory architecture, comprising:
when a first key received from a client is stored in the cache in association with a pointer to a remote memory:
sending a command and the first key to the remote memory;
receiving a plurality of key-value pairs from the remote memory based on the first key, a second value at the remote memory corresponding to the first key to specify the key-value pairs for retrieval from the remote memory; and
sending the key-value pairs to the client.

16. The method of claim 15, further comprising:
creating a first list of keys corresponding to cache objects having been least recently accessed at the cache;
sending the first list of keys to the remote memory;
receiving an eviction candidate queue from the remote memory, the eviction candidate queue comprising a second list of keys corresponding to at least some of the cache objects indicated as candidates for removal from the cache, wherein the eviction candidate queue is based on the first list of keys; and
removing at least one of the cache objects from the cache based on the eviction candidate queue when a request to add a new cache object is received from the client and the cache is full.
